(19) United States
(12) Patent Application Publication
(10) Pub. No.: US 2011/0320383 A1
(43) Pub. Date: Dec. 29, 2011

(54) Stock market filters

(76) Inventor: Cherng Chang, Rowland Heights, CA (US)

(21) Appl. No.: 12/803,301

(22) Filed: Jun. 24, 2010

(51) Int. Cl. G06Q 40/00

(52) U.S. Cl. 705/36 R

(57) ABSTRACT

Seven filters are disclosed for further improving the power of the present RTS software, as well as any real time stock software with filtering capability. The first filter is for quickly searching and disclosing all recent trend box signal(s) (TBS(s)) within a specified time period, for the user, preferably less than 60 minutes prior to the filter processing time. The second filter is for finding and disclosing a trend box (TB) reversal after a user specified number of TB(s) of the same color. The third filter involves a term, NO % D, which expresses net open percent difference, the difference between the net open percent of a stock, NO % (stock), and that of a reference, typically the Standard Poor 500 index, NO % ($SPX). The fourth filter involves a similar term N % D. Both these two filters allow the user the choice to set limits of these terms to filter out groups of stocks suitable for trade entries. With the filters 5 and 6, the computer will filter a group of stocks to find filtered stocks each having bar height and bar's closing price, respectively, in rising or falling sequence, suitable for trade entries. The last filter employs two small visual alert sheets to alert the user the appearance of an up TBS and a down TBS, respectively, in the last five minutes, good opportunity for trade entry.

### FIELD OF THE INVENTION

The present invention relates to methods providing a user real time stock market data and information helpful for market entry.

### BACKGROUND OF THE INVENTION

In 2006, Betrader Financial Inc. (Cupertino, Calif.) released Version 2 of its RTS-STD real time stock software program. A more recent product RTS-PRO is available through its website http://www.betrader.com.

Once a user signs in RTS-PRO, a main viewing window 10 as shown in FIG. 1 will appear. The user may click the “New Chart” button 11 in this window to create a new chart in real time for his chosen stock. He can click the “New Quote” button 12 to enter one or more stocks to view and analyze. Such quote sheet may also display a group of indices designed by Betrader for viewing and analysis.

The “Show Layers” button 14 allows user to select one of four layers that RTS displays. Although the layers are numbered to identify them, they can be viewed in any order. The user can also choose to hide particular layers here.

The “New Scan” button 13, once clicked, will open a blank lift/filter sheet. This sheet has two buttons activatable by the user. The first one is a “List” button 32, shown in FIG. 3, which allows the user to open a list either from the market in real time or the user's stock listing files. The second button is a “Filter” button 33, also shown in FIG. 3, which allows the user to select one or more pre-designed filtering criteria to be applied to the above list for selecting and opening a subgroup of stocks in this list for viewing and analysis by the user.

Shown in FIG. 2 is a current version of the List Filter panel 20 in the RTS-PRO program. It is opened once the Filter button 33 is clicked. For example, an intraday trader only wants to trade stocks satisfying the following conditions:

1. Daily trading volume larger than 800,000 shares. This is achieved as shown in FIG. 2 by clicking the box 21 next to “Average Volume Greater Than” and entering “800” in the box 22 to the right.

2. Stock price greater than $30. This is achieved by clicking the box 23 next to “Price Greater Than” and entering “30” in the box 24 to the right.

3. Trading volume 180% or more of the average trading volume. This is done by clicking the box 25 next to “Vol/Ave Vol Greater Than”, and then entering “180” in the box 26 to the right. Once all above conditions have been made as shown in FIG. 2, the user will click the “OK” button 28 and open a list/filter sheet.

FIG. 3 shows the list/filter sheet 30 listing 10 stocks meeting the filtering criteria specified as shown in FIG. 2. This list/filter sheet is color linked with a chart display window 40 shown in FIG. 4. This display window is set to display on the layer 3 which is shown on a 42″ TV acting as a terminal extension to the PC station. The screen size of this TV is large enough to display 20 charts, for 10 stocks each having a 1 day and 5 min chart pair. One pair 41 is set aside for displaying a reference, such as Dow Jones, SP 500 or Nasdaq, while the other nine pairs 42 are linked to the list/filter sheet 30 shown in FIG. 3, using a common color of blue 43 on the upper right corners of each stock chart and the list/filter sheet. Since only nine stocks can be displayed, the number 10 stock is not shown, but can be displayed by sliding the right cursor 34 on the list/filter sheet downward. Using the present RTS-PRO, it may take only about ten seconds to set these criteria and find the stocks. On the other hand, it would take much longer time to find such information using other methods.

In the RTS-PRO, a stock chart is typically represented by a group of candlesticks. Each candlestick comprises a body section or bar, and two lines vertically extending from the bar. The bar indicates the opening and closing price of a stock in a unit of 1 day, 1 week, 5 min or other time period. A white or green bar indicates a rising price, and a black or red bar indicates a falling price. The two black lines, if seen, indicate the highest price and lowest price during this period.

In the RTS-PRO, a term “trend box” (TB) is employed, which is a box covering one or more candlesticks. Similar to the candlestick, a TB can also be either green or red, lay on top of the corresponding candlestick(s).

When there is a new green candlestick appeared with its high exceeding the high of the preceding green trend box, a new green trend box is formed, usually. The high of this new green TB will be equal to the high of this new green bar. The low of this new green trend box is automatically set the same as the high of the preceding TB. This green trend box will continue cover all succeeding candlesticks until a new trend box is formed.

Conversely, when there is a new red bar appeared, with its low falling below the low of the preceding green TB, a new red TB is formed, usually. The low of this new red TB will be assigned same as the low of the new red bar. The high of this new red TB will be the same as the low of the preceding green TB. This red TB will be extended until another new TB is formed. The formation of a new red or green trend box right after a red TB can also be similarly constructed.

In the RTS-PRO, a term “trend box signal” (TBS) is also used. This TBS is similar to a conventional three lines break (3LB), which usually refers to a trend reversal when a rising bar immediately follows three consecutive falling bars or a falling bar immediately follows three consecutive rising bars. Such trend reversal represents a good time for entry either for long or short.

In RTS-PRO, a TBS can be either an up green arrow or a down red arrow. A green TBS is assigned to a price chart at a place where there is a reversal typically from three consecutive red trend boxes to a green trend box, while a red TBS is assigned to a price chart at a place where there is a reversal typically from three consecutive green trend boxes to a red trend box. This trend box reversal is an improvement over the conventional 3LB, mainly due to the elimination of some noise associated with the use of candlesticks, and makes the reversal more reliable.

In RTS-PRO, the TBS are placed in the charts to point out the best time for a trader to enter a long trade or short trade. There is a filter 27 in RTS-PRO, “TB Bullish or Bearish Reversal After ______ same color TB”, as seen in FIG. 2. There are two problems with this filter. First, this filter doesn't deal with TBS specifically. Second, there is no indication of the timing on the appearance of a TBS. Very often the golden opportunity for profitable trade presented by each TBS only last as short as 5-10 minutes. If the user executes this filter, say, 3 hours after the New York stock opening, he will get a listing of many stocks meeting the filter criteria having at least one TB reversal. But the problem is that many reversals happen long past the golden opportunity for profitable trade and have become useless. Lot of precious time is wasted in going through all these charts and then found that they are useless.

Therefore, it would be more beneficial that a filter could be devised that it not only can scan the data base to find out the stocks showing TB reversal after several same color TB, but also limit the reporting to only stocks having such reversal in the past 10, 20 minutes or some assigned short time duration. Furthermore, it would be even better if a TBS, i.e., a green or red arrow, happening within a specified short time window could be searched and reported. It would assure that all reported stocks are not only fresh, but also valid with its TBS assurance.

### SUMMARY OF THE INVENTION

Seven filters are disclosed for further improving the capability of the present RTS software as well as any real time stock software with filtering capability. These seven filters are mainly applied for intraday swing trading, in which both buy and sell of the same stock are done in a single day. But it may also be used for multiple days swing trading if the market condition favors the holding of the purchased stocks for more than one day.

The first filter is for quickly searching and disclosing all recent trend box signals (TBS) within a user specified time period, preferable less than 60 minutes prior to filter processing time, for the user. The user may timely enter a trade for long, short or other trades including options, etc., based on this TBS information as well as the overall market condition.

The user may initiate one such filtering by first clicking the New Scan button. A empty list/filter sheet will appear. The user will next click the List button to select a database, which is either a stored stocks file or a group of stocks from the market in real time. Once a selection is made, the modified RTS-PRO will extract all data for each selected stocks including its real time price as well as many derived information, and load them to the list/filter sheet.

The next step for the user is to click the Filter button to open a List Filter panel similar to FIG. 2, but with all seven added filters displayed. He next chooses TBS, Up or Down TBS, a last time period, 10 min, 20 min, or a specified duration, during which one or more up or down TBS have appeared. A click on the OK button will start the filtering process. Upon the completion of the filtering, a list/filter sheet will appear, showing a list of stocks meeting the filtering criteria. All real time price and related information on each of these stocks will be loaded to this list/filter sheet. Through a color linkage mechanism, one or more charts for each stock will also be displayed for the user.

The second filter is similar to the first filter. It can be used only when it is felt that TB reversal after three TB of the same color is not solid enough, and four or more TB of the same color will be needed before TB reversal can happen.

The third filter involves a term, NO %, net open percent, which expresses the percent change from the current day's opening. For a stock, the value of NO % (stock) is typically driven by two force components. The first component is the net open percent of the market, or a reference, NO % (reference), such as $DJI or $SPX. The second component is a factor unique to this stock, due to the fundamental of this stock. A new term, NO % D, can be introduced as

NO % D=NO % (stock)−NO % (reference)

or =NO % (stock)−NO % ($SPX), if the reference is $SPX.

Most “average” stocks will move up or down at the same rate as the reference, which means their NO % D value is zero or near zero. A positive NO % D for a stock means that this is a strong stock with good fundamental. In an up market, or positive NO % ($SPX), the rate of increase in the price of this stock is faster than that of the reference. In a down market, or negative NO % ($SPX), the rate of decrease in price of this stock is slower than that of the reference. Investment in this stock will likely have profitability higher than that of an average stock during an up market, or a loss less than that of an average stock during a down market. It is suggested that a trade long can be placed in this stock, preferably during an up market, along with many other favorable market conditions. Conversely, a negative NO % D for a stock means that this is a weak stock with poor fundamental. It is suggested that a trade short be placed in this stock, preferable during a down market.

The third filter for trading long or short may also be combined with the appropriate filter 1 or 2. It means that for trading long, the filtered stocks not only each has a TBS or TB reversal suitable for trading long, each stock is also a strong stock with higher profitability than that of an average stock. It also means that for trading short, the filtered stocks not only each has a TBS or TB reversal suitable for trading short, each stock is also a weak stock with faster falling rate than that of an average stock.

For a long or short trading based on the NO % D filter, the user has the choice to set the limit of NO % D value, in order to adjust the number of filtered stocks displayed to a manageable level. A sorting of such NO % D value is also provided for the user to choose the most desirable stocks for trade.

The fourth filter is based on another new term, N % D, net percent difference, which expresses the difference between the net percent change of a stock from previous day's closing price, N % (stock), and that of a reference, typically, N % ($SPX). The use of this filter is similar to the third filter, but is most suitable for multiple days swing trading.

With the filter 5, the computer will filter the list stocks to find out stocks each with its present bar above or below last, typically 3 or more, 5 min bars. This filter is very good for long or short trade, respectively. In a stable market, with not many TB reversal or TBS, such stocks may be the most feasible stocks for trade.

It is a great idea that the above/below filter 5 be combined with an appropriate NO % D or N % D filter. When a stock meets both filters for long, it indicates that this stock is not only in a continuous up rising trend, but also outperforms other rising stocks in its higher profitability. It is also true if a stock meets both filters for short.

The filter 6 is similar to the filter 5 except that the item to be compared for the filter 6 are the closing price of the present bar and the closing prices of the specified number of preceding bars. The above or below filter can also be used alone or in combination with an appropriate NO % D or N % D filter. Compared with the filter 5, the use of the closing price for comparison is more statistically valid and preferred.

The filter 7 employs a small visual alert sheet placed on a corner of the PC screen to alert the user the presence of an up and/or down TBS in the last 5 minutes or other preset duration. The appearance of the bright green up arrow and/or the bright red down arrow constantly reminds the user that there are more profitable investing opportunities out there.

In summary, the above seven filters may provide the user many potentially profitable opportunities for trade entries. Twenty or more trade entries can be made in a typical days. But only four stocks are active at a time. Most trade each may last no more than 30 minutes, and must be exit once the price becomes stagnant, for keeping the gain and freeing up the cash for the next promising trade. In such a fast pace action, more time will be spent on trading, less time on searching and study of stocks, especially on those stocks leading to no trading. Each investment dollar may be recycled four or more times for maximum profit.

### BRIEF DESCRIPTION OF THE DRAWINGS

FIG. 1 shows the main viewing window opened at the start of the RTS-PRO program.

FIG. 2 shows a List Filter panel of the RTS-PRO program.

FIG. 3 shows a list/filter sheet displaying a group of stocks meeting the filtering criteria specified in the List Filter panel as shown in FIG. 2.

FIG. 4 shows a 42″ TV screen acting as a PC terminal extension for displaying 20 charts for viewing.

FIG. 5 shows a list of seven filters of the present invention and criteria for each filter to be specified by the user.

FIG. 6 shows a flow diagram of the filtering process for finding and listing all stocks among the 259 sector stocks that each has an up TBS in the last 20 minutes.

FIGS. 7 and 8 show the 1 day, and 5 min charts, respectively, of the stocks IBM which was filtered out with an up TBS on the 5 min chart within the last 20 minutes prior to the filtering time 14:10, Apr. 26, 2010.

FIGS. 9 and 10 show the 1 day, and 5 min charts, respectively, of the stocks RIG which was filtered out with an down TBS on the 5 min chart within the last 20 minutes prior to the filtering time 11:20, Apr. 26, 2010.

FIG. 11 shows a flow diagram of the filtering process for finding and listing all stocks among the 259 sector stocks that each has calculated NO % D value higher than 1%.

FIG. 12 shows a flow diagram of the filtering process for finding and listing all stocks among the 259 sector stocks that each has calculated NO % D value less than −1.5%.

FIG. 13 shows three price charts (1 day, 5 min, 1 min) and one NO % D chart of IBM after the long trade of this stock shortly after 14:10 Apr. 26, 2010.

FIG. 14 shows a flow diagram of the filtering process for finding and listing all stocks among the 259 sector stocks that in each stock the present bar is above all specified number of preceding 5 min bars.

FIG. 15 shows a flow diagram of the filtering process for finding and listing all stocks among the 259 sector stocks that in each stock the closing price of the present bar is above the closing price of all specified number of preceding 5 min bars.

FIG. 16A show a small visual green alert sheet to alert the user on the appearance of at least one up TBS in the last 5 minutes.

FIG. 16B show a small visual red alert sheet to alert the user on the appearance of at least one down TBS in the last 5 minutes.

FIG. 17 shows a flow diagram of the filtering process for finding at least one up TBS in the 259 sector stocks in the last 5 minutes, and if so, placing the up green arrow in the green alert sheet.

FIGS. 18-21 show the 1 day, 5 min, 1 min and NO % D charts for the stock DDS displayed in the layer 2 chart display window after the long trade of this stock at 10:31, Jun. 1, 2010.

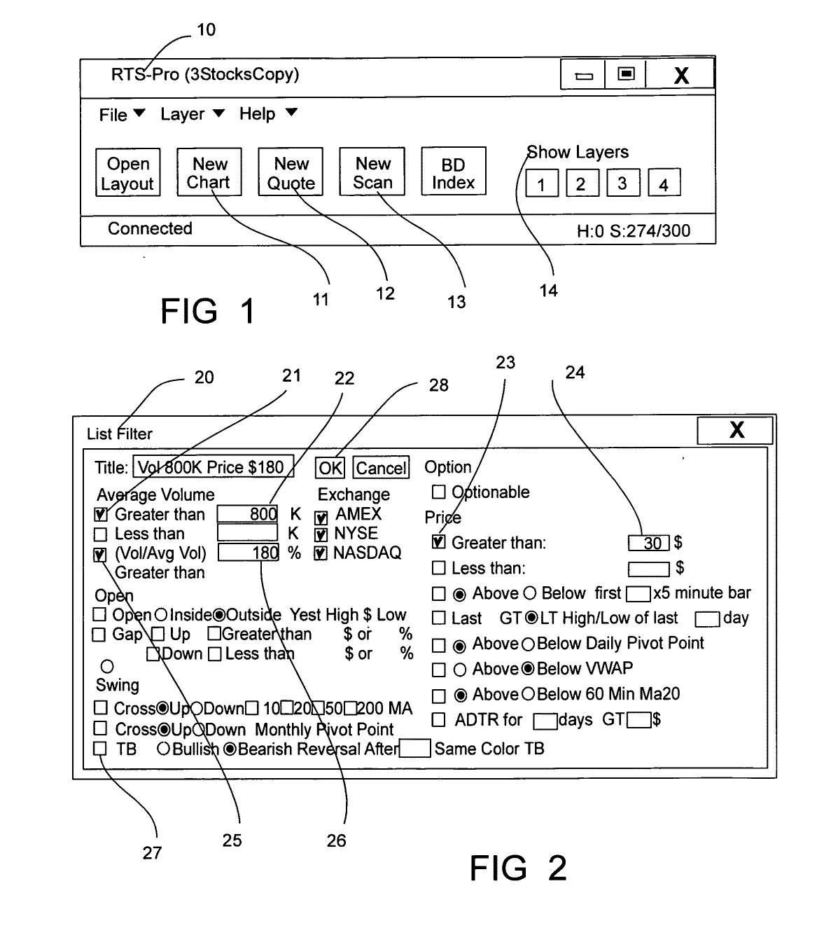

### DETAILED DESCRIPTION

Shown in FIG. 5 are seven filters for further improving the capability of the present RTS software as well as any real time stock software with filtering capability. These seven filters are mainly applied for intraday swing trading, in which both buy and sell of the same stock are done in a single day. But it may also be used for multiple days swing trading if the market condition favors the holding of the purchased stocks for more than one day.

For the sake of explanation, a new term “modified RTS-PRO” is used here to refer to the current RTS-PRO program that has been modified to incorporate all needed revision for successfully running all seven filters of the present invention. Although such modified RTS-PRO program is not yet in existence, any person skilled in the art would be able to make such modification based on the teaching of the present application. In order to make the distinction, the term “RTS-PRO” now on will refer to the current RTS-PRO program without any modification.

### Filter 1: TBS

The filter 1, 51 shown in FIG. 5 is the one to be added to the LIST FILTER panel 20 shown in FIG. 2. This filter is for quickly searching and disclosing all recent TBS for the user to timely enter a trade for long, short, or other trades including option, etc.

For example, a user sits in front of a computer on Apr. 26, 2010 at 14:10 EST, can enter this filter by clicking the box 58 beside the word “TBS” and the circles 59 and 61 beside the words “up” and “20 min”, respectively, as shown in FIG. 5, and the “OK” box 28 shown in FIG. 2. Such clicking is essentially an order given by the user to the modified RTS-PRO program to find out and list all stocks in the data base that each such stock has an up TBS, i.e., an up green TBS arrow, in the last 20 minutes.

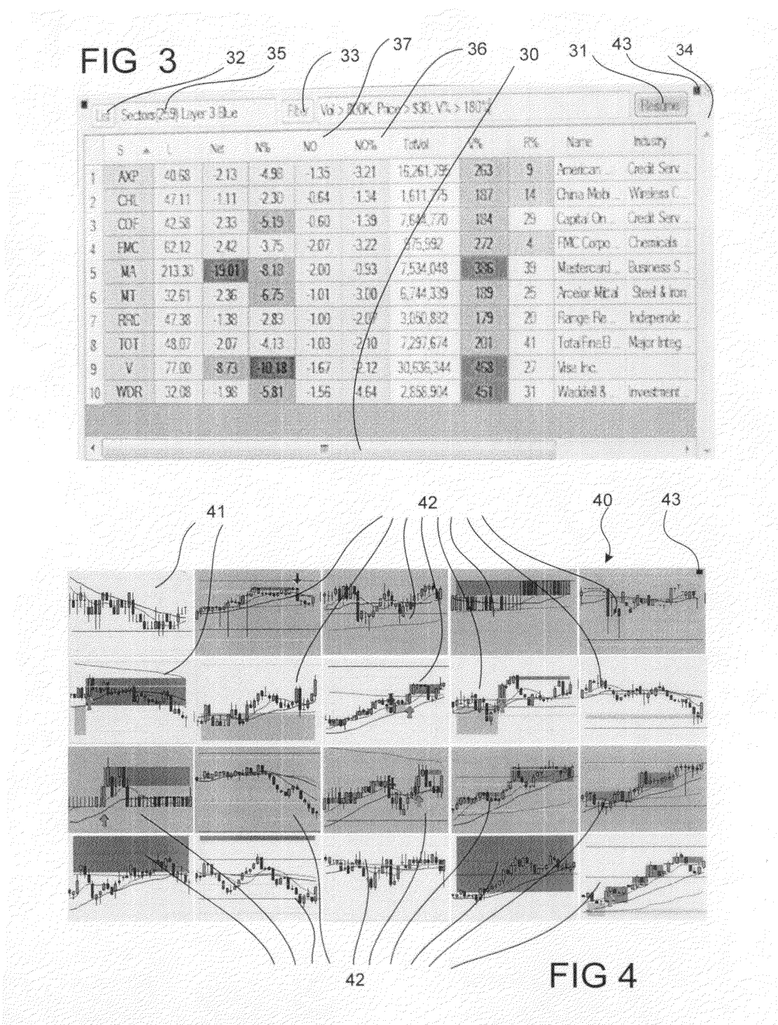

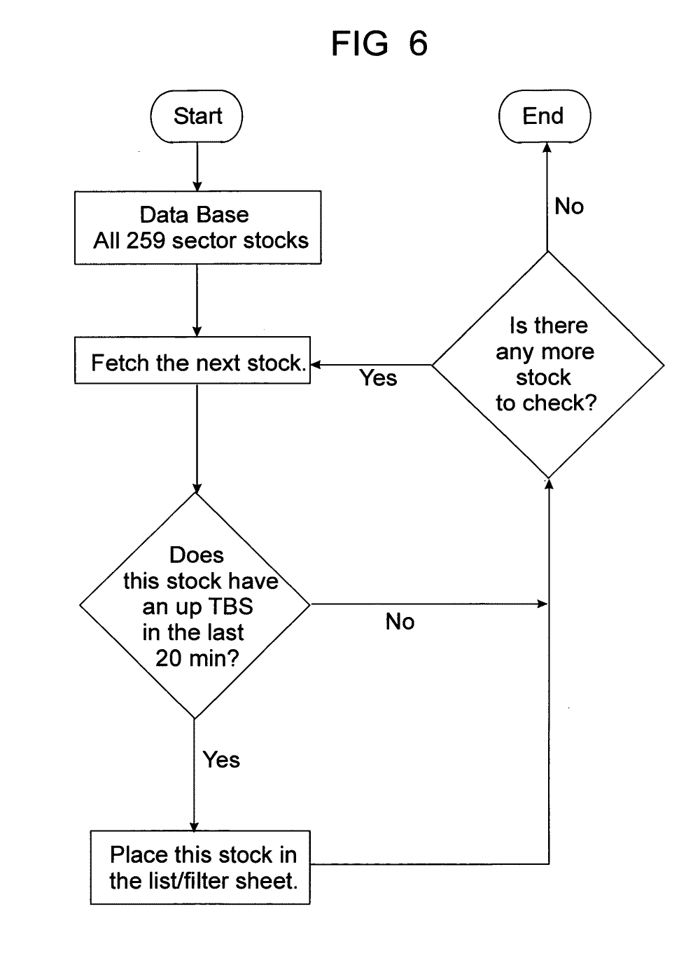

FIG. 6 is a flow diagram showing the filtering process done by the modified RTS-PRO program. It starts out with the database to be filtered, which are still the same 259 sector stocks 35 as shown in FIG. 3. Before the start of this filtering, the RTS-PRO program already has processed these 259 stocks with each stock's chart data and all up/down TBS stored in its database, up to this time. As seen in FIG. 6, the computer running the filter 1 in the modified RTS-PRO will check each stock and place all stocks each having an up TBS in the last 20 minutes in a list/filter sheet similar to the one shown in FIG. 3.

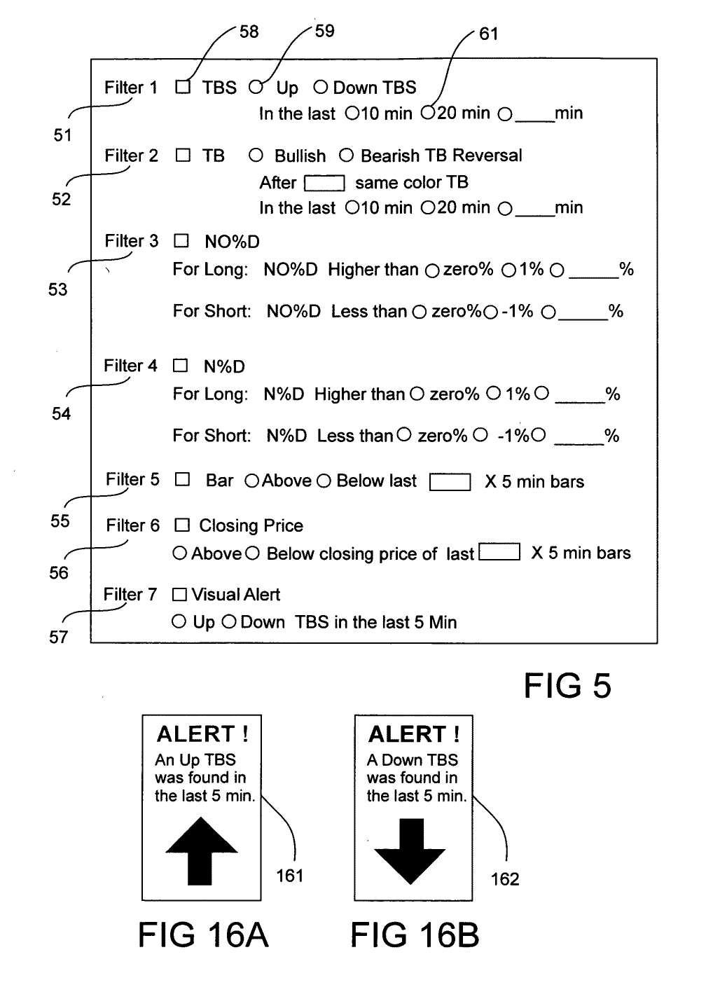

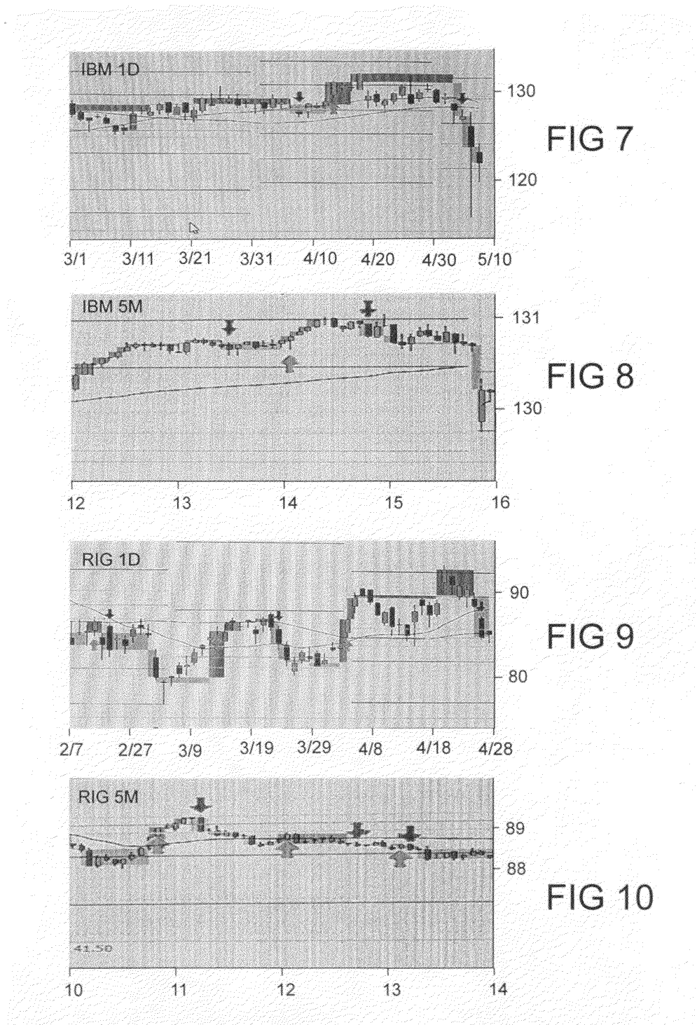

One of the stocks discovered by this filter and listed in the list/filter sheet is the stock IBM. Since this sheet is color linked to a chart display window in layer 3 similar to FIG. 4, the user will immediately find out the 1 day and 5 min charts for IBM as shown in FIGS. 7 and 8, respectively. It should be noted that the charts shown in FIGS. 7 and 8, are not the real time charts, but obtained after the market has closed in April 26, and shown here for the sake of explanation only. The real time charts would only show the trace up to the viewing time of 14:10 EST on that day.

At this point the user needs to quickly study this IBM stock to decide whether to place a buy order. He needs to check whether the overall market is in up trend. He may also find that this IBM chart is currently above indicators such as VWAP, and PP. All these positive indications could convince him to place a long trade shortly after 14:10 EST.

Similar to the up TBS, the down TBS is also very valuable for indicating an ideal time for trade entry. As an example, this user also starts a filter 1 at 11:20 EST the same day for the following request:

“Down TBS in the last 20 min.”

The flow diagram for this filtering is similar to the one shown in FIG. 6, except the word “up” is now replaced by the word “down”.

The resulted down TBS list/filter sheet is a separate sheet and different from the up TBS list/filter sheet above described. The stock symbols listed in this sheet is color linked to a layer 4 chart display window, which is set up for displaying 20 charts in the same manner as the chart display window in FIG. 4 (layer 3). One stock listed in this sheet is RIG for Transoscan Inc. FIGS. 9 and 10 show the two charts (1 day and 5 min) in layer 4, also obtained after close for illustration purpose. If all indicators are favorable, the user may enter a short trade shortly after 11:20 EST.

It is noted that in FIGS. 7 to 10 the TBS appears in both the 1 day and 5 min charts. Clearly, the TBS on the 5 min chart should be used for the filter 1 operation in intraday trading. Although there are also TBS appearing on the 1 day chart, they will not be considered by the filter for intraday trading. Beside 5 min chart, other charts using different unit of time, such as 1 min, 2 min, 10 min, 15 min, etc., can also be used for TBS filtering. However, very short time unit such as 1 min, 2 min tends to be somewhat noisy and unreliable. On the other hand, chart based on longer time unit such as 10 min or 15 min, may produce TBS too slow to respond to the change of the stork price.

It should be noted that once a TBS filter process is initiated, the filtering becomes an ongoing process and is repeated every few seconds. This means that the listed stocks in the list/filter sheet can be changed as a result of each filtering process. The user needs to continue watching this sheet to consider whether a new trade entry is needed on the appearance of a new TBS.

In the present example, around 14:30 that day the list/filter sheet and the linked chart display window in Layer 3 will no longer include IBM, because by then there is no longer any up TBS on the IBM chart in the last 20 minutes. It is important that once a trade has been entered, the user must manually relocate it in order to monitor it continuously. A quote sheet and its color linked chart display window in layer 2 are set aside for this purpose. This layer 2 chart display window also can display 20 charts, for four stocks and a reference such as $SPX. Each stock has three price charts (1 day, 5 min, 1 min) and a NO % D chart, which will be described in a latter section. All these four charts are linked by a common color to the quote sheet and will show up once the symbol of the entered stock is typed in the quote sheet. The 1 day and 5 min charts of IBM are the same as that shown in FIGS. 7 and 8, respectively. The 1 min chart will be used for indicating an early warning for exit.

The present RTS-PRO program also allows the user to stop this repeated filtering in order to concentrate on the stocks currently on the list/filter sheet. This is achieved by clicking the “Pause” button on the upper right of the sheet and converting the button display from “Pause” to “Resume”. At a latter time the user can also restore the repeated filtering by clicking the Resume button and converting the button display back from “Resume” to “Pause”. Of course the user can also click the “X” button on the top right corner of the sheet anytime to turn off this sheet.

It is noted that the list/filter sheet in the current version of RTS-PRO has two types of lists. The first type of the list is a fixed list, which normally is imported into RTS-PRO from a computer file such as a “My Scan List”. The other type list is coming from the market in real time. But it will first go through a filter-like screening to select only those stocks from the market that meet certain specified screening criteria. For example, a screening listed under the “Swing Modules” in the List is termed “Bullish TB Reversal (TBRU)” seen in the most current TRS-PRO program. This screening is virtually the same as the filter 27 “TB Bullish Reversal After 3 Same Color TB” included in the LIST FILTER panel 20 shown in FIG. 2. For the present discussion such screening is filter-like and will be actually considered as a filter. The only difference is that this filter is used to filter the real market instead of a fixed database.

It is worthwhile emphasizing that the TBS filter can also be combined with a volume filter. In the List Filter panel shown in FIG. 2, there is already a volume filter “(Vol/Ave Vol) greater than ______%”. It filters out stocks whose intraday volume accumulated from open is larger than the average trading volume of the same interval during the past five days or longer period. When such filter is exceeding 100%, or even 150%, and coupled with an up TBS, there is a strong momentum behind the purchase of this stock. It may cause the price upward trend to persist for a while longer.

### Filter 2: TB

This filter 2 is similar to the filter 1. It can be used to replace the filter 1 only when it is felt that TB reversal after 3 TB of the same color in not solid enough, and 4 or more TB of the same color will be needed before TB reversal can happen. The flow diagram for filter 2 is similar as the one for filter 1 in FIG. 6, except that the words “up TBS” are now replaced by the words “bullish reversal after ______ same color TB” or the words “bearish reversal after ______ same color TB”. The timing criteria for the filter 2 is the same as in filter 1.

### Filter 3: NO % D

As seen in FIG. 3, RTS-PRO employs two headings, NO 37 and NO % 36, for each listed stock. NO stands for net open, which states the change in price of each stock from the current day's opening price. NO % stands for net open percent, which expresses the percent change from the current day's opening. NO and NO %, as well as all other headings, typically refreshes every few seconds. A positive NO and NO % mean that the current price of the stock is higher than its opening price, while a negative NO and NO % mean that the current price is lower than its opening price.

For a stock, the value of NO % (stock) is typically driven by two force components. The first component is the net open percent of the market, or a reference, NO % (reference), such as $DJI or $SPX. The second component is a factor unique to this stock, due to the fundamental of this stock. A new term, NO % D, can be introduced as

NO % D=NO % (stock)−NO % (reference)

or =NO % (stock)−NO % ($SPX), if the reference is $SPX.

Most average stocks will move up or down at the same rate as the reference, which means their NO % D value is zero or near zero. A positive NO % D for a stock means this is a strong stock with good fundamental. In an up market, or positive NO % ($SPX), the rate of increase in price of this stock is faster than that of the reference. In a down market, or negative NO % ($SPX), the rate of decrease in price of this stock is slower than that of the reference. Investment in this stock will likely have profitability higher than that of an average stock during an up market, or a loss less than that of an average stock during a down market. It is suggested that a trade long can be placed in this stock, preferably during an up market, along with many other favorable market conditions. Conversely, a negative NO % D for a stock means that this is a weak stock with poor fundamental. It is suggested that a trade short be placed in this stock, preferable during a down market.

For a long trading based on the NO % D filter 53, the user has the choice to decide whether the NO % D value must be above 0%, 1%, or any positive percentage entered by the user. This option will allow the user to adjust the total number of filtered stocks with best long trade profitability.

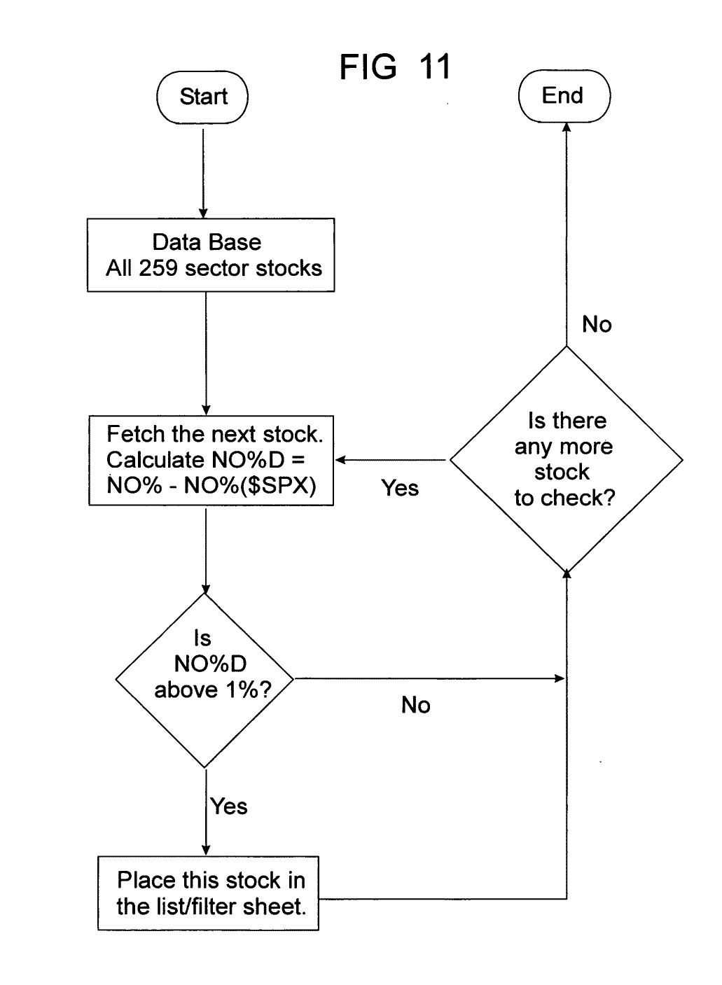

FIG. 11 shows the flow diagram for filtering the data base in order to find out all stocks that have NO % D value higher than 1%, and place all these stocks in a list/filter sheet accepting this NO % D filter. This sheet is also color linked with a chart display window on layer 1 for displaying up to nine stocks listed in the sheet at a time. For each stock, a 5 min price chart and a chart of NO % D vs. time, to be described later, are displayed.

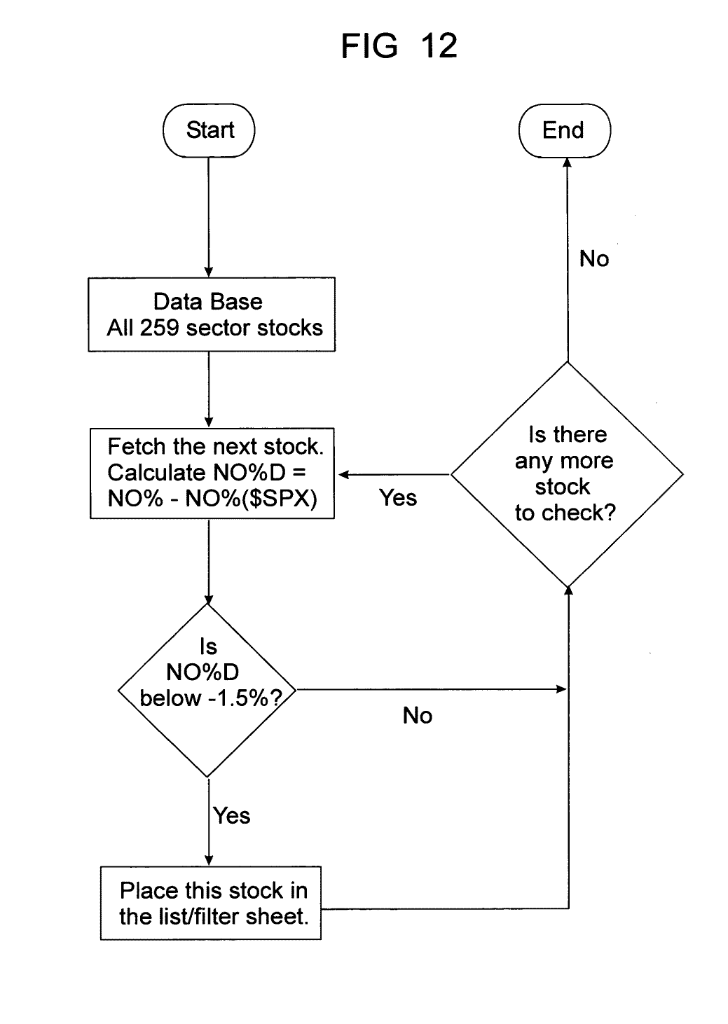

The filter 3 for trading short also allow the trader a choice to select whether the NO % D value must be below 0%, −1%, or any negative percentage entered by the trader. FIG. 12 shows the flow diagram for filtering the stocks in the data base in order to find all stocks that have NO % D value below −1.5%, a number entered by the trader. All found stocks can be placed in a list/filter sheet, which is color linked with a chart display window on layer 1. Although the long NO % D filtering and the short NO % D filtering can be conducted at the same time, the two list/filter sheets can only be color linked to the layer 1 display one at a time.

It is not necessary, but highly desirable; to also include a listing of all calculated NO % D data in all stocks in the list/filter sheet. The list/filter sheet shown in FIG. 3 has 11 data columns or headings displayed. But the current version of the RTS-PRO allows as many as 36 headings to be displayed in this sheet. A one time revision on this sheet can allow the NO % D as the 37th column displayable on the sheet. In this case, the NO % D column can be sorted according to the size of the NO % D value in order to find out the best-qualified stocks for analysis and trade.

In FIG. 11, a step of the calculation of the NO % D is included. But if the NO % D is included as one heading, its value can simply be calculated internally since the value of the NO % (stock) and NO % ($SPX) are available as a function of time. In this case, the calculation step in the flow diagram of FIG. 11 will no longer be needed. The value of NO % D can be updated every few seconds just like all other headings. But the stocks included in the list/filter sheet will still be changed as a result of each filtering process. This process will repeat itself at a preset frequency as long as the “Pause” button on the upper right corner of the list/filter sheet as seen in FIG. 3 is not changed to “Resume” by the user.

It is noted that the present NO % D criteria does not set any restriction on the value of NO % (stock) or NO % (reference). A trader may follow the general rule that long daily trade be entered only when the general market is up, i.e., NO % (reference) is positive. A short daily trade be entered when the general market is down, i.e., NO % (reference) is negative.

The third filter for trading long or short may also be combined with the appropriate filter 1 or 2. It means that for trading long, the filtered stocks not only each has a TBS or TB reversal suitable for trading long, each stock is also a strong stock with higher profitability than that of an average stock. It also means that for trading short, the filtered stocks not only each has a TBS or TB reversal suitable for trading short, each stock is also a weak stock with faster falling rate than that of an average stock.

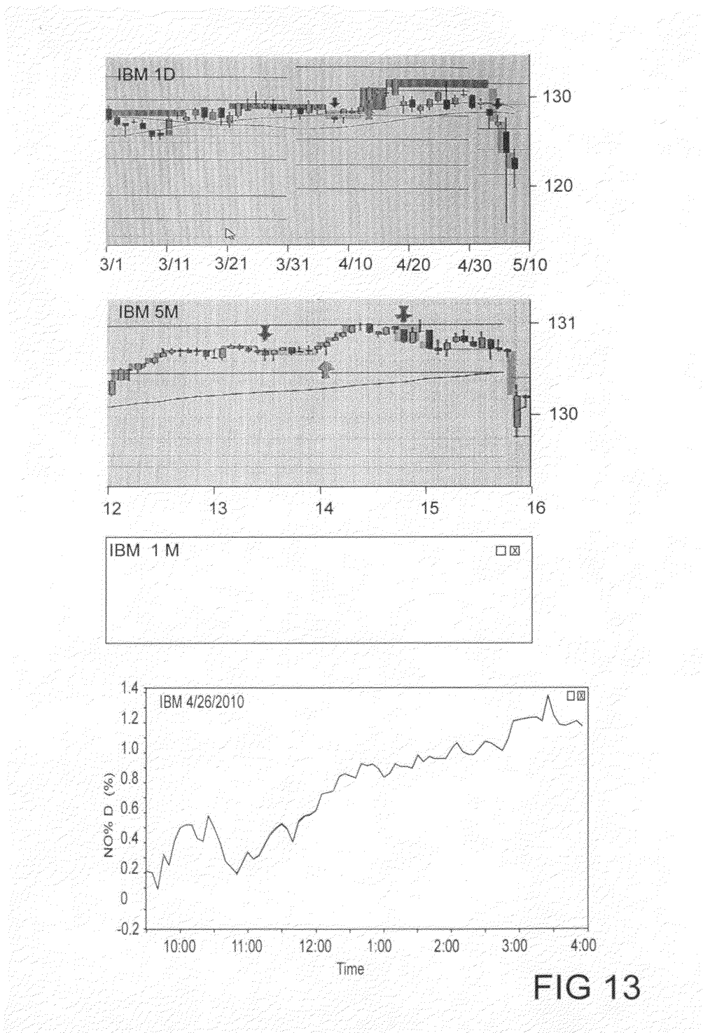

Once a stock is entered as a result of long or short NO % D filtering or NO % D combined with filter 1 or 2, the investor needs to type this stock's symbol on a blank or expired stock chart on the layer 2 chart display window to display 4 charts of the entered stock. FIG. 13 shows one example of the IBM stock from the April 26 trading. The 1 day and 5 min charts are copied from FIGS. 7 and 8, respectively. The 1 min chart data is not available for demonstration and just presented as a blank box.

The last chart on FIG. 13 is a NO % D chart manually recreated based on the available NO % (IBM) and NO % ($SPX) data, for the sake of illustration. With the available NO % D data, a real time plot of NO % D vs. time can be easily made using the chart-making program available in the RTS-PRO software.

As seen in FIG. 13, over the entire period, the NO % D is in the positive territory. At the viewing time 14:10 this value just reaches 1.0%. Furthermore, this NO % D chart follows an up moving trend, which may predict the further increase of the NO % D number beyond the current time. All these positive factors may further validate the up TBS and assure a profitable long trade.

### Filter 4: N % D

As seen in FIG. 3, RTS-PRO also employs two headings, N (Net) and N %, for each listed stock. N stands for net, which states the change from previous day's closing price. N % stands for net percent, which states percent change from previous day's closing price. A positive N and N % means that the current price of the stock is higher than yesterday's closing price. A negative N and N % means that the current price of the stock is lower than the yesterday's closing price.

Similar to NO %, the N % value of one stock can also be compared with the N % value of one reference. A new term N % D can be introduced, which equals to N % (stock)−N % ($SPX), if the reference is $SPX.

The filter 4 in FIG. 5 for trading long or short is very similar to the filter 3 for trading long or short, except by replacing the opening price by the yesterday's closing price. The use of this filter by itself or along with the filter 1 or 2 is also very similar to the filter 3. Compared with the filter 3, filter 4 is more often used for multiple days swing trading.

The flow diagrams for filter 4 are not shown, but are very similar to the flow diagrams for filter 3 shown in FIGS. 11 and 12. In these cases, each character string “NO” must be replaced by the character “N”.

### Filter 5: Bar

As seen in FIG. 2, the RTS-PRO employs a filter “Above or Below first ______×5 min bar”. This filter is very useful, perhaps during the first hour of the stock market opening. However, after the first hour this filter may not be very relevant anymore. The immediate trend leading to its current price may become the main consideration.

With the filter 5 in FIG. 5, the computer running the modified RTS-PRO will filter the data base to find out stocks, each with its present bar above or below last, typically 3 or more, 5 min bars. This filter is very good in finding continuously rising or falling stocks for long or short trade, respectively. In a stable market, with not many TB reversal or TBS, such stocks may be the only feasible stocks for trade.

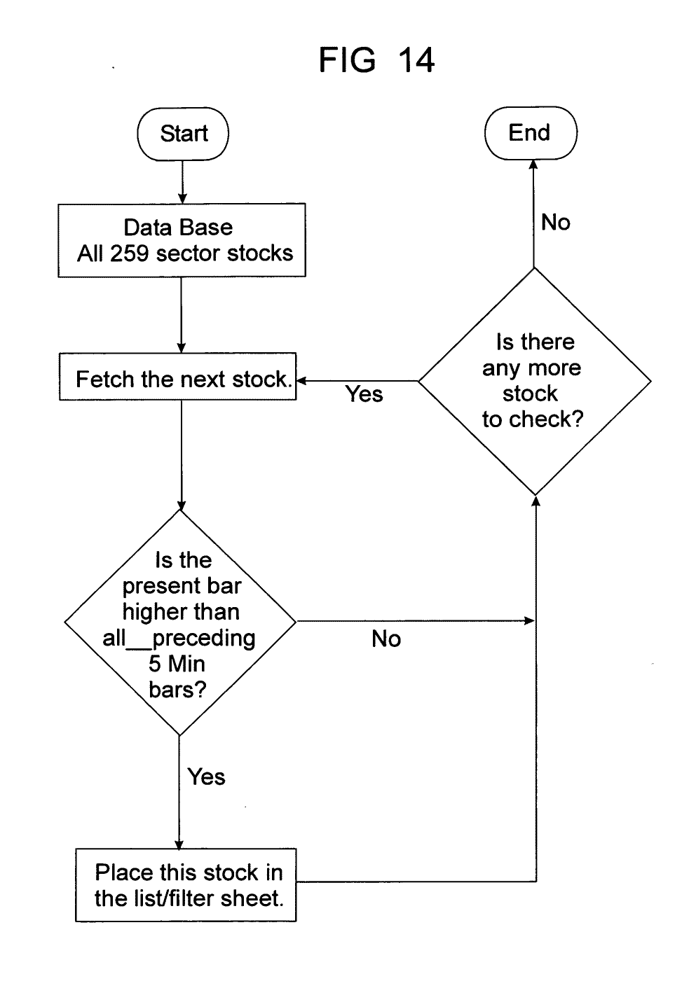

FIG. 14 shows the flow diagram for the present filter in finding the stocks, with each stock's present bar higher than all ______ preceding or last 5 min bars. This flow diagram also works for finding each stock with its present bar lower than all ______ preceding 5 min bars, by simply replacing the word “higher” by the word “lower” in the flow diagram. The discovered above and below stocks will be shown in two list/filter sheets, and displayed in the layers 3 and 4 chart display windows, respectively. The entered stocks must be entered in the layer 2 chart display window for monitoring.

As is clear from FIG. 14, the present bar is higher than all specified preceding bars. It doesn't matter whether the present bar is a rising green bar or falling red bar, as long as it is higher than all specified preceding bars. It also doesn't matter any one of the specified preceding bars is a green rising bar or a falling red bar, as long as it is lower than the present bar. It should be noted that only the rectangular bar of each candlestick in the chart would be used in this comparison. The vertical black lines sticking out of each bar indicating the highest price and lowest price in each candle stick time period will not be considered.

The purpose of the present filter 5 is to find a steadily rising or falling stock. But this is not a sure thing. The investor must check all other indicators such as volume, PPC, and VWap before making a trade. Unlike a TB reversal stock, this continuously rising or falling stock doesn't have a strong momentum favoring its continued movement in the same direction. After entering the trade, the investor must closely watch the charts and exit the trade once the 1 min and 5 min charts indicate a sign of price stagnation.

It is suggested that the filter 5 not be combined with the filter 1 or 2 due to their different nature. Filter 5 is to be used in a steady market for finding continuously rising or falling stocks. On the other hand, the filter 1 or 2 is to be used in a volatile market for finding many TB reversal or TBS stocks. The filter 5 may not be needed if the market presents many profitable TBS stocks.

On the other hand, it is a great idea that the filter 5 be combined with the NO % D or N % D filter. When a stock meets both filters for long, it indicates that this stock is not only in a continuously up rising trend, but also outperforms other rising stocks in its higher profitability. It is also true if a stock meets both filters for short.

### Filter 6: Closing Price

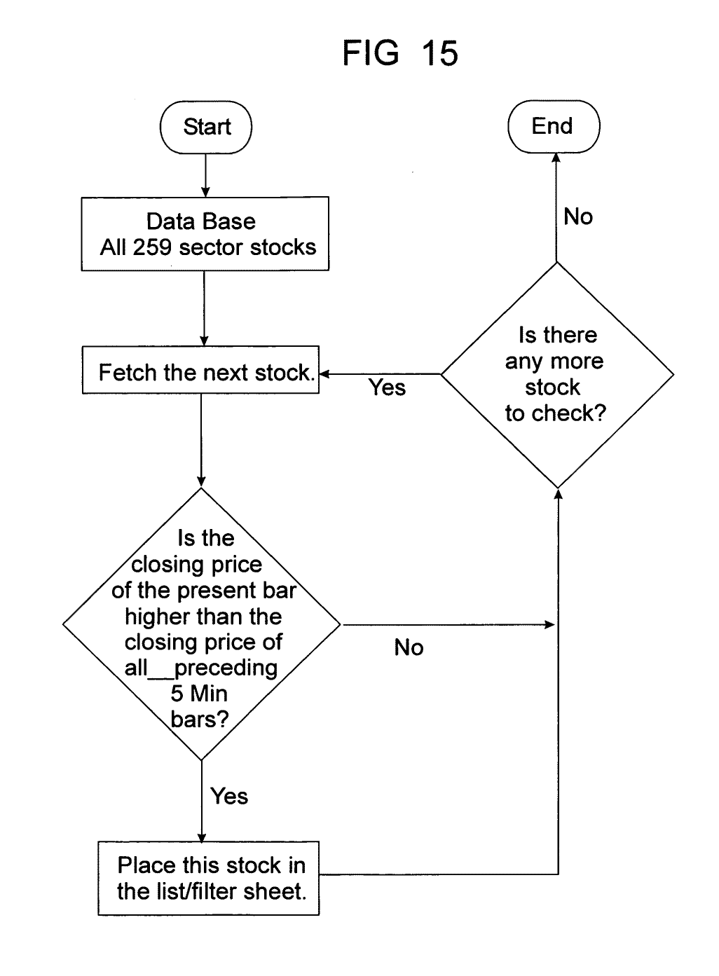

The filter 6 in FIG. 5 and its flow diagram shown in FIG. 15 are very similar to the filter 5 and its flow diagram, respectively. The items to be compared for filter 6 are the closing price of the present bar and the closing prices of the specified number of the preceding bars.

Compared with the filter 5, the use of the closing price is more statistically valid, because for a 5 min chart, the time apart between two adjacent prices is always 5 minutes. It should be the filter of choice.

The filter 6 can be used alone, or in conjunction with a NO % D or N % D filter. The filtered above and below closing price stocks can be listed in two list/filter sheets, respectively, and color linked with layers 3 and 4, respectively, chart display windows. Each entered stocks also need to be typed into the layer 2 chart display window for continued monitoring.

### Filter 7: Visual Alert

FIGS. 16A and 16B show two small visual alert sheets 161 and 162, placed on a corner of the PC screen to alert the user on the appearance of an up TBS and down TBS, respectively, in the last 5 minutes, potentially good for trade entry. In the present example, both the up green arrow and the down red arrow are shown, which means that at least one up TBS and one down TBS have appeared in the last 5 minutes. If only one of the two arrows appears, then it means that only one type of the two TBS (up and down types) has appeared at least once in the last five minutes. If no arrow is shown, then it means that no TBS has been found in the last 5 minutes. Since these alerts update once a few seconds, it always reveal the current status of the present market.

It should be noted that these alerts don't tell which stocks or how many stocks have the up TBS or down TBS in the last 5 minutes. If the trader wants to follow up on this lead, he must activate the filter 1 for either up TBS or down TBS or both for the display of all stocks meeting the alert criteria. Of course each filtered stock must be further investigated to see whether this stock is indeed suitable for long or short entry.

FIG. 17 shows the flow diagram for the present filter in finding at least one up TBS in the last 5 minutes, and update the FIG. 16A alert sheet every few seconds accordingly. The flow diagrams for selecting down TBS can also be drafted similarly, by simply replacing the word “up” by the word “down”, and the word “green” by the word “red” in FIG. 17.

The present visual alert filter serves its purpose as an alert. It sits at a corner of the PC screen. It updates itself every few seconds. The bright green up and/or bright red down arrow constantly reminds the investor that there are more profitable investing opportunities out there. It may encourage the trader to take a close look at his current stock holdings and to exit one or more holdings with stagnant price movement, and free up the cash for more stock entries with larger profit potential.

An example is described here to illustrate the benefit of the TBS alert system. During a down market day, one green up TBS arrow suddenly appears at 10:30, Jun. 1, 2010 in the alert sheet. The user immediately responded to this signal by activating one up TBS filter 1. The stock showing this TBS signal was found to be DDS (Dillard, Inc.). After briefly studying the 5 min chart he timely entered the buy trade at 10:31.

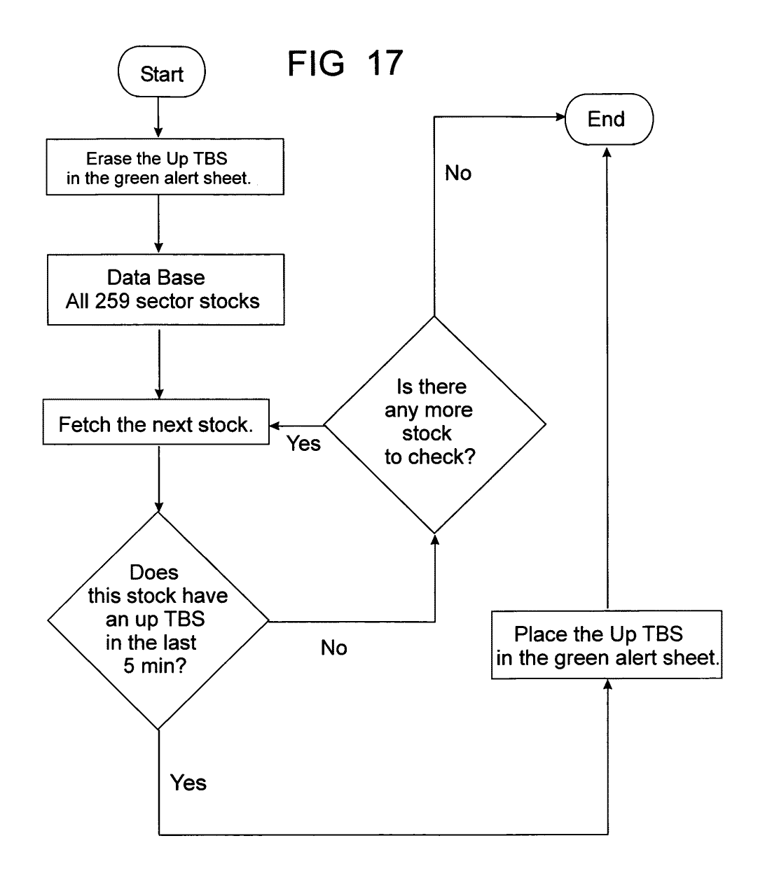

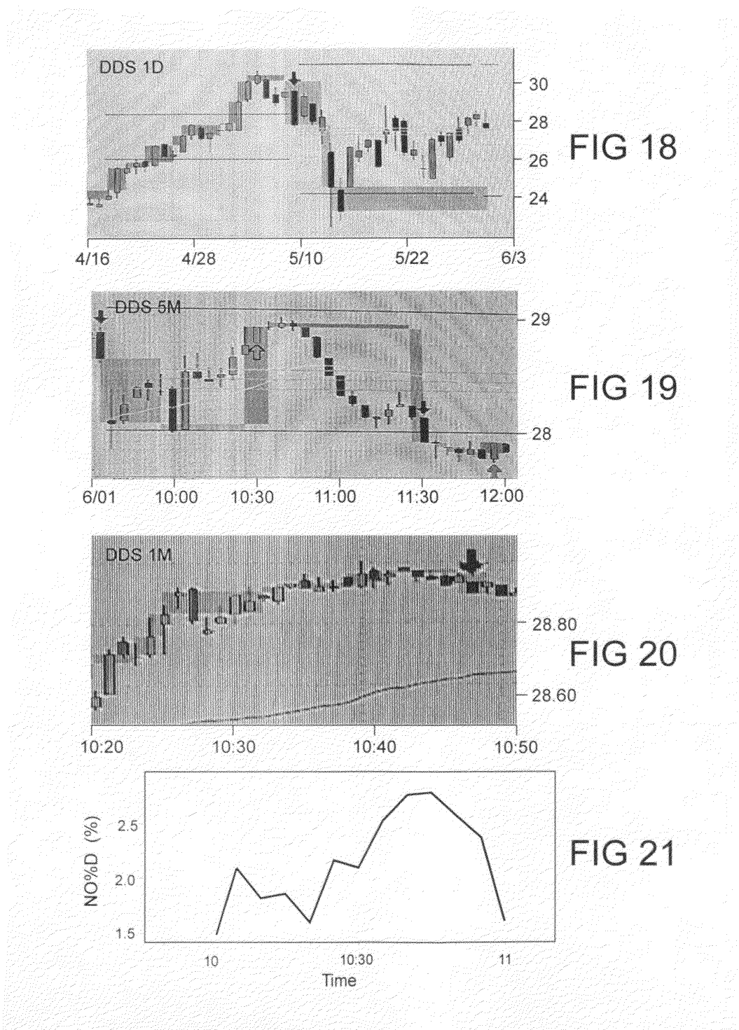

After entry the user opened all four charts for this stock, as shown in FIGS. 18-21, for monitoring. Unfortunately, after a short rise, the price of this stock became stagnant. The trader made a timely exit at 10:44 for a small gain of 0.21%. This trade wouldn't have been possible without the TBS alert.

It is interesting to point out that a NO % D chart is also shown for this stock as seen in FIG. 21. The trader realized if he had started a filter 3 up NO % D by itself, to search for stocks with NO % D higher than 2%, he would have discovered this stock DDS nearly 7 minutes before the appearance of the TBS in the alert. If he made the entry 7 minutes earlier, and with the same exit as before, his profit would have been tripled.

As a matter of fact, the NO % D>2% filter would have uncovered this stock an even earlier time at 10:05 that day. A timely entry would have a gain of more than 1%. This fact indicates that a high value NO % D, especially the one with continuously rising percentage, may be quite beneficial in uncovering promising stocks for long, not found by or earlier than TBS. Same is also true for NO % D for short.

The invention having thus been described, the following is claimed:

1. A method of providing a user real time stock market data, and information helpful for market entry, comprising the steps of:
A. running a software program, for obtaining real time stock market data,
B. generating price charts and TBS(s) for a group of stocks and placing said TBS(s) on said charts,
C. executing a filter for filtering said group of stocks for finding at least one TBS of said TBS(s) with its appearance time within a specified time range prior to said executing time.

2. The method of claim 1, in which said filter is a computer program for filtering said group of stocks for finding a sub-group of stock(s) each having said one TBS with its appearance time within said specified time range prior to said executing time.

3. The method of claim 2, also comprising the step of:
D. executing a second filter for filtering said sub-group of stocks for finding stocks each having a intraday volume accumulated from open larger than the average trading volume of the same interval during the past five days or other multiple days period.

4. The method of claim 2, in which said generated TBS(s) is/are up TBS(s).

5. The method of claim 2, in which said generated TBS(s) is/are down TBS(s).

6. The method of claim 2, in which said time range is 20 minutes prior to said executing time.

7. The method of claim 2, in which said time range is less than 60 minutes prior to said executing time.

8. The method of claim 1, in which said filter is a computer program for
a. filtering said group of stocks for finding said one TBS, and
b. displaying a TBS on an alert sheet to alert said user the appearance of said one TBS.

9. The method of claim 8, in which said specified time range is 5 minutes.

10. A method of providing a user real time stock market data and information helpful for market entry, comprising the steps of:
A. running a software program for obtaining real time stock market data,
B. generating said information including price charts, NO, NO %, and NO % D for a group of stocks, and
C. executing a filter for filtering said group of stocks for finding stock(s) meeting user specified criteria on said NO % D.

11. The method of claim 10, in which said filter is a computer program for filtering said group of stocks for finding a sub-group of stocks, with each stock of said sub-group having NO % D greater than a minimum value helpful for trading long,

12. The method of claim 11, in which said minimum value is 0%.

13. The method of claim 11, in which said minimum value is user specified.

14. The method of claim 11 also comprising the step of:
D. generating TBS(s) information for said sub-group and placing TBS(s) on said price charts, and
E. executing a second filter for filtering said sub-group for finding at least one up TBS with its appearance time within a specified time range prior to said executing time.

15. The method of claim 11, in which
a. each said stock of said sub-group has a price chart showing a series of bars, each of said bars having a width representing a defined time unit, and heights showing an opening price and a closing price during said time unit, and
b. said method also comprising the step of:
D. executing a second filter for filtering said sub-group of stocks for finding a sub-subgroup of stock(s), each having a closing price of the present bar higher than the closing price(s) of a specified number of bar(s) preceding said present bar.

16. The method of claim 10, in which said filter is a computer program for filtering said group of stocks for finding a sub-group of stock(s), with each stock of said sub-group having NO % D less than a maximum value helpful for trading short.

17. The method of claim 16, in which said maximum value is 0%.

18. The method of claim 16, in which said maximum value is user specified.

19. The method of claim 16 also comprising the step of:
D. generating TBS(s) information for said sub-group and placing TBS(s) on said price charts, and
E. executing a second filter for filtering said sub-group for finding at least one down TBS with its appearance time within a specified time range prior to said executing time.

20. The method of claim 16, in which
a. each said stock of said sub-group has a price chart showing a series of bars, each of said bars having a width representing a defined time unit, and heights showing an opening price and a closing price during said time unit, and
b. said method also comprises the step of:
D. executing a second filter for filtering said sub-group of stocks for finding a sub-subgroup of stock(s), each having a closing price of the present bar lower than the closing price(s) of a specified number of bar(s) preceding said present bar.
